(19) United States
(12) Patent Application Publication
(10) Pub. No.: US 2007/0211936 A1
(43) Pub. Date: Sep. 13, 2007

(54) Colour Specification

(75) Inventors: Robert Dornan, Strathclyde (GB); Anthony Edward Durnian, Strathclyde (GB)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: J & P Coats Limited

(21) Appl. No.: 11/736,624

(22) Filed: Apr. 18, 2007

Related U.S. Application Data
(63) Continuation of application No. 10/240,804, filed on Jun. 11, 2003, now Pat. No. 7,221,373.

(30) Foreign Application Priority Data
Apr. 4, 2000 (GB) 0008102.6

(51) Int. Cl. G06K 9/00

(52) U.S. Cl. 382/162

(57) ABSTRACT

A color chart is constructed by defining a reference color and specifying a range of colors from the reference color, where each color in the range is spaced from any other color by integral multiples of a preselected color difference value, such as at least one CMC value. One or more colors of the range are displayed in a form that can be visually perceived by a user, such as displaying the color(s) on a computer monitor or printing the color(s) on one or more sheets of paper. The method allows color charts to be prepared that lend themselves to an orderly, objective identification of the colors.

Colour charts are prepared by manufacturers of paints, inks, dyestuffs and coloured products as diverse as motor vehicles and sewing threads. Usually, they are published as printed colours, laid out in some sort of array, on paper, but swatch cards are also produced by, for example, manufacturers of fabrics, laminates and so forth in which the colours are shown on the fabric or laminate itself. The colours are selected in accordance with the preferences of an individual or panel of people, perhaps after some market research, and assigned more or less fanciful names such as Nile Green or Dusky Peach. Disclaimers are often made as to the reproducibility of the chart colours, especially in regard to the differences brought about by application to the intended substrate as compared with the chart colour on its paper substrate.

Some colour charts, comprehensive enough to be termed ‘colour libraries’ are necessarily arranged in some kind of logical order. Among these may be mentioned the CIELAB colour model, and the Pantone, Scott Dic and Munsell systems. At least one of these libraries has been transferred from the physical samples to an electronic version in which the colours are stored as brightness, hue and chroma values for displaying a colour on a colour monitor. A problem with electronic representation, of course, can be appreciated by casual observation of television sets in a dealer's window—not all the sets will be showing the same colour despite receiving the same signal.

A shortfall of all of these systems is that by no means all available colours are represented. Even though, typically, there may be some 1700 colours in such a library, manufacturers are not infrequently asked for ‘specials’, colours not represented by chart colours.

The present invention provides methods for preparing colour charts, colour charts prepared by such methods and apparatus for displaying colour charts and colours therefrom that do not suffer the disadvantages of prior art charts and their display and which have considerable advantages to those concerned with the specification or production of colour and coloured articles.

The invention comprises, in one aspect, a method for preparing a colour chart comprising the steps of
defining a reference colour, and
specifying a range of colours from said reference colour, each colour being spaced by integral multiples of a preselected colour difference value from any other colour, the range spanning the colour space between the reference colour and some other colour

Typical colour difference values are CMC values. The preselected colour difference value may be at least one CMC value and may desirably be in the region of two CMC values.

A CMC value (as specified by the Colour Management Committee) is a trade-wide adopted standard for colour differentiation. It is defined as the difference, in CIE colour space, comprising differences in hue, chroma and lightness between a specified and an achieved colour, as specified by the CMC formula. It renders numeric measures of colour difference which are generally accepted as being visually uniform i.e. the same magnitude of CMC value is the same colour difference irrespective of the colour.

Whilst it is possible to contemplate charts for green, red or other subsets of the entire gamut of colour, the invention is most meaningful when the whole gamut is covered. The reference colour, then, may be the deepest possible black, or the purest and brightest possible white.

This method of specifying colours fills the colour space extending from deepest black to brightest white and encompassing red, green, yellow and blue, with approximately 17000 colours. There is little or no point in specifying finer differences than are commercially only just distinguishable. The number is larger—far larger than any other commercial colour chart—but manageable. Because of the structure of the chart, it lends itself to an orderly, objective, rather than subjective, identification of the colours. While many systems could be devised, a straightforward, easily understandable system is to label each colour with an alphanumeric code of the form AA123. The potential range of available code numbers is 676000, which is far larger than is required for the 17000 or so colours of the full chart so there is perhaps, room for interpolation, should it for any reason be desired to add further colours. On this basis, jet black could be represented as AA000 and whitest white by ZA000.

The invention also comprises a colour chart comprising a range of colours specified for a defined reference colour each colour being spaced by integral multiples of a preselected colour difference value from any other colour, the range spanning the colour space between the reference colour and some other colour. The reference colours may be white, black, or, indeed any other colour and the range may comprise those colours in the colour space which are spaced from an adjacent colour by at least one CMC value, preferably by about two CMC values, e.g. 1.8 or 2.2 CMC values.

Of course, it would not be possible to make any meaningful colour chart for the whole of colour space on a single sheet of paper. Rather, sub-ranges can be indicated, using the labelling method outlined above, by the alpha part of the code on a segment of a circular colour map, and the chart proper can be on a page-by-page basis for colours represented by codes beginning AA, AB, AC, . . . BA, BB BC, . . . ZA, ZY, ZZ.

Obviously, such a “chart” could run to 676 pages, and might be unmanageable for many purposes. The chart can, however, be represented digitally for display via a programmed computer on a colour monitor, and the invention also comprises apparatus for displaying a colour chart comprising
a colour video monitor, and
a computer programmed to specify a range of colours extending from a defined reference colour each colour being spaced by integral multiples of a predetermined colour difference value from any other colour, the range spanning the colour space between the reference colour and some other colour
the computer being connected to the monitor and controllable to display at least one colour of the range thereon.

Having regard to the problems of displaying colours alluded to above, it is preferred that the monitor is calibratable, both internally to itself and externally to the computer, so that the colour actually displayed corresponds to the specified colour. The monitor can be calibrated with reference to standard colours by means of a colorimeter. Rather than resort to the usual colour adjustments available on colour monitors, it may be that the colour signals sent between the computer and the monitor are adjusted (the adjustments being, for example stored in a database which is consulted each time a colour signal is transmitted) by means of a feedback from the colorimeter.

In much the same way, a colour printer can be calibrated to print colours which match the screen colours or a set of standard colours.

While the measures described above can be used to produce a colour chart and to display its colours accurately on screen or printed on to paper, there remains the problem of producing the finished product be it a textile product, a ceramic, a leather, a laminate or whatever, which involves the production of an appropriate colorant which it will perform on the substrate to which is will be applied. Textile dyestuffs, for example, will yield different colours on different substrates, for example, substrates having different textures. This problem can also be addressed in conjunction with the invention.

In another aspect, then, the invention comprises apparatus as aforesaid in which the computer contains a database of colour recipes from which a particular recipe is desired representative of a colour displayed on the monitor which will produce the actual colour when applied to a particular substrate. The database will contain different recipes for the same colour but for application to different substrates. The recipes may be in digital format which, for a perfect screen, would display the called-for colour, and the machine contain programming modifying the instructions to the screen (or printer, as the case may be) to produce the colour called for. The programming may include an algorithm, which will be a method of working out a recipe for example for paints, inks and/or dyes. The computer, in other words, may include programming adapted to modify the instructions on the basis of a different substrate, as outlined above.

The invention will now be described with reference to the drawings, in which:

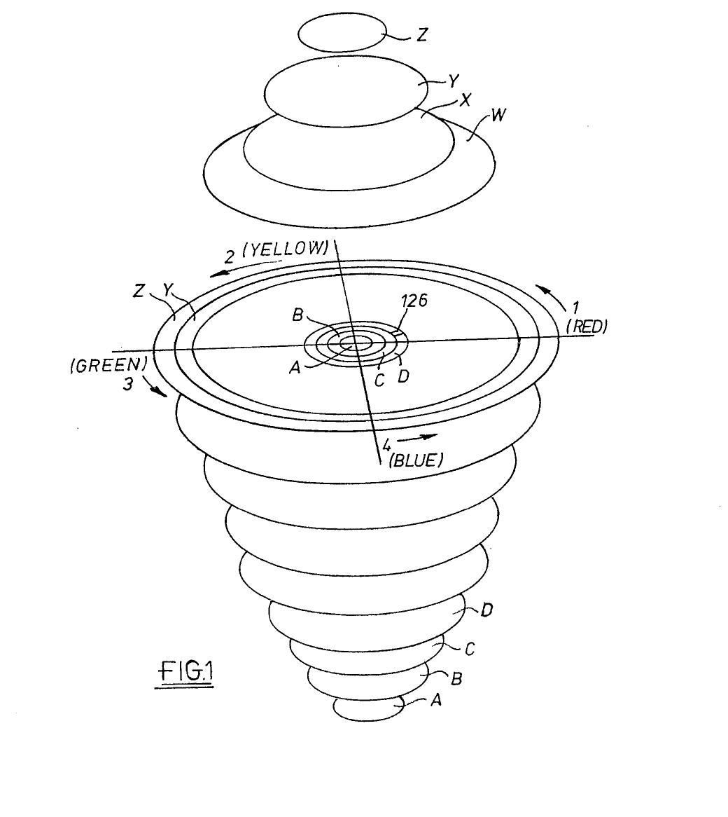

FIG. 1 is a colour map such as might be used in connection with the invention;

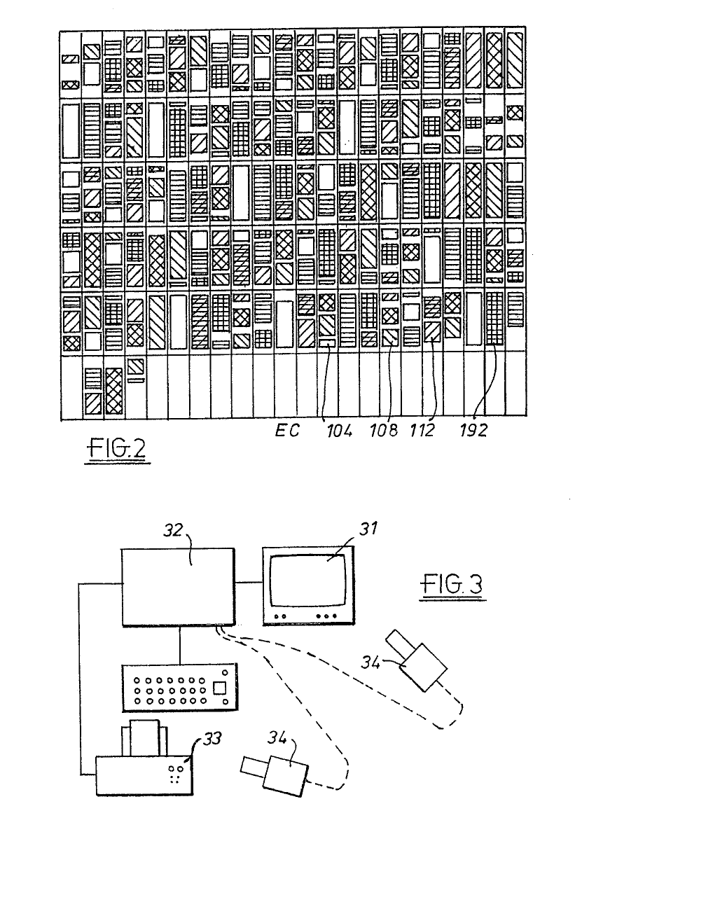

FIG. 2 is of an example of a page of colours from a colour index prepared according to the invention; and

FIG. 3 is a diagrammatic illustration of apparatus useful in connection with the preparation and display of colours in a colour chart according to the invention.

The drawings illustrate a method for preparing a colour chart 11 comprising the steps of
defining a reference colour, eg black (AA000, FIG. 1) or white (ZA000, FIG. 1) and
specifying a range of colours from said reference colour (AA000 or ZA000), each colour being spaced by integral multiples of a preselected colour difference value from any other colour, the range spanning the colour space between the reference colours and some other colour.

The colour difference values are CMC values.

FIG. 1 illustrates the coding system. The first letter of the code is an indication of lightness. A being dark, Z being bright, a letter late in the alphabet indicating a lighter colour than a letter earlier in the alphabet.

The lightness/darkness spectrum is depicted in planes A, B . . . Y, Z.

The second letter denotes to chroma circle, A denoting the “bull's eye”. B, D . . . Z denoting the first, second etc circles outside this, a letter later in the alphabet denoting a less intense shade than one earlier in the alphabet.

The first numeric digit denotes which of the four quadrants the colour appears in, quadrant 1 extending from red to yellow (thereby encompassing orange shades) quadrant 2 extending from yellow to green, quadrant three from green to blue, and quadrant 4 from blue, through purples, back to red.

The next two digits represent the distance around the colour circle from the beginning of the quadrant. Thus 126 represents the twenty sixth point around the first quadrant, thus a reddish orange colour. The full coding BD126 thus represents a point on circle D in the second lightness plane, 26 points around the circle from the beginning of quadrant 1, thus a dark, intense reddish orange colour.

With a little experience, any colour denoted by this coding in the form xxnnn can be fairly readily visualised.

FIG. 2 shows a typical page from a compendium of all colours of a colour chart according to the invention. The page, selected, as it were, at random from all the pages labelled AA to ZA, is page EC and contains 25 colours, EC100, EC108, EC106, . . . EC192, EC196. Other pages will be similar. Of course, other configurations can be adopted. The pages can be pages of a paper publication or ‘pages’ of text and graphics in a computer.

Of course, different coding systems can be adopted, but the one particularly herein described appears well suited for adoption as a standard.

FIG. 3 illustrates apparatus for displaying a colour chart comprising a colour video monitor 31 and a computer 32 programmed to specify a range of colours between to reference colours each colour being spaced by an integral multiple of two CMC values from any other colour, the range spanning the colour space between the two reference colours, and the computer 32 being connected to the monitor and controllable to display at least one colour of the range thereon.

A colour printer 33 is also connected to the computer 32—inasmuch as a printer is essentially a printing VDU, although not so fast in response nor so flexible in operation as a VDU—the colour printer 33 is auxiliary to the video monitor 31. Provision for internal calibration is desirable so that it may be ensured that signals passed to the monitor or printer from the computer always result in the same colour being displayed or printed.

Likewise, adjustment may be made for changes in the appearance of a colour when it is applied to different substrates. This may be done exactly as described, namely by comparing the screen or printed image with a colour on a particular substrate, or the effect of colorants such as dyestuffs on different substrates such as woven or knitted fabrics, fabrics which have and fabrics which have not been bleached, and so on, can be taken into consideration in a database loaded into the computer and consulted when a dye recipe, for example, for dyeing onto ecru cotton fabric is required.

1. A method for preparing a colour chart comprising the steps of:
defining a reference colour;
specificying a range of colours from said reference colour such that each colour is spaced from any other colour by integral multiples of a preselected colour difference value, the range spanning the colour space between the reference colour and some other colour; and
displaying at least one of said colours in a form that can be visually perceived by a user.

2. A method according to claim 1, in which the reference colour is black.

3. A method according to claim 1, in which the reference colour is white.

4. A method according to claim 1, in which the preselected colour difference value is at least one CMC value.

5. A method according to claim 4, in which the preselected colour difference value is between 1.8 and 2.2 CMC values.

6. A colour chart comprising a range of colours specified for a defined reference colour such that each colour is spaced from any other colour by integral multiples of a preselected colour difference value, the range spanning the colour space between the reference colour and some other colour.

7. A colour chart according to claim 6, in which one of the reference colours is black.

8. A colour chart according to claim 7, in which one of the reference colours is white.

9. A colour chart according to claim 6, in which the range of colours comprises those colours in the colour space that are spaced from an adjacent colour by at least one CMC value.

10. A colour chart according to claim 9, in which the colours are spaced by between 1.8 and 2.2 CMC values.

11. A colour chart according to claim 6, wherein the colour chart is represented digitally.

12. Apparatus for displaying a colour chart, comprising:
a colour video monitor; and
a computer programmed to specify a range of colours extending from a defined reference colour such that each colour is spaced from any other colour by integral multiples of a predetermined colour difference value, the range spanning the colour space between the reference colour and some other colour;
the computer being connected to the monitor and controllable to display at least one colour of the range thereon.

13. Apparatus according to claim 12, in which the monitor is calibratable.

14. Apparatus according to claim 13, in which the monitor is internally calibratable.

15. Apparatus according to claim 13, in which the monitor is externally calibratable.

16. Apparatus according to claim 13, comprising a colour printer.

17. Apparatus according to claim 16, in which the printer is calibratable.

18. Apparatus according to claim 13, in which the computer contains a database of colour recipes from which a particular recipe is selectable representative of a colour displayed on the monitor, which will reproduce the actual colour when applied to a particular substrate.

19. Apparatus according to claim 18, in which the database contains different recipes for the same colour but for application to different substrates.

20. Apparatus according to claim 18, in which the recipes are in digital format which, for a perfect screen, would display the colour called for, the machine containing programming modifying the instructions to the screen to produce the colour called for.

21. Apparatus according to claim 20, in which the programming includes an algorithm, which is a method of working out a recipe for paints, inks and/or dyes.
